(19) United States
(12) Patent Application Publication
(10) Pub. No.: US 2004/0031255 A1
(43) Pub. Date: Feb. 19, 2004

(54) Twisted and self-sharpening lawn equipment blades

(76) Inventor: Mark Kenny, Jensen Beach, FL (US)

Correspondence Address: TANGENT LAW GROUP, 1201 PENNSYLVANIA AVE, WASHINGTON, DC, 20004, US

(21) Appl. No.: 10/636,810

(22) Filed: Aug. 8, 2003

Related U.S. Application Data
(60) Provisional application No. 60/401,778, filed on Aug. 8, 2002.

(51) Int. Cl. A01D 34/52

(52) U.S. Cl. 56/295

(57) ABSTRACT

A cutting blade, especially a blade for lawn equipment, comprising at least one spindle section and at least one blade member. The blade member extending radially from the at least one spindle section along a longitudinal axis of the blade member. The blade member terminating in a distal end and having a direction of rotation. The blade member having a first surface and second blade surface. An at least one cutting surface connecting the first and second blade surface at a cutting angle relative to the plane of the second blade surface. Also, the blade has an at least one trailing surface relative to the direction of rotation of the blade member. The blade member having a twisted portion rotated at a twist angle substantially throughout the entire cross section of said twisted portion.

### CROSS REFERENCE TO RELATED APPLICATIONS

This application claims benefit of the earlier filed U.S. Provisional Application No. 60/401,778 filed Aug. 8, 2002, which is incorporated herein by reference.

### BACKGROUND OF THE INVENTION

1. Field of the Invention

The invention relates to a lawn equipment blade, particularly to a blade having a twisted cross-section along the longitudinal axis of the blade substantially throughout its length and a blade with at least one self-sharpening cutting surface.

2. Background of the Invention

The effective management of landscape waste such as grass clippings, leaves, twigs, and other lawn remnants or landscape materials is a principal problem in the lawn maintenance industry. The waste is unsightly when left on the grass after landscape maintenance. So, whether mechanically or manually, these unsightly remnants are usually removed and disposed of, which is both costly and labor intensive. Typically, these remnants are bagged in plastic lawn bags. Fully 60% of the industry is still using bags to collect and dispose of generated clippings. Bagging often means more wear and tear on machinery and the added expense of hauling grass clippings to a compost or a disposal site, which boosts labor and fuel costs and wastes time. Time is money for the lawn maintenance contractor.

Bagging is also environmentally costly. For example, the average California lawn generates 300 to 400 lbs. of grass clippings per 1,000 sq. ft. annually, according to the California Integrated Waste Management Board. More than six million tons of these clippings, and the corresponding plastic bags, end up being hauled off lawns and disposed of through municipal waste programs, comprising approximately 15 percent of that state's waste. The volume of this waste nationwide was so significant that the Environmental Protection Agency was recently prompted to make yard waste its number one target for landfill bans, since grass clippings made up 20.1 percent of all solid landfill waste annually according to the Professional Lawn Care Association of America. As a result, grass clippings are now often banned from landfill disposal.

In addition to the added costs and environmental concerns associated with hauling and disposal methods, removal of the cut grass reduces nitrogen levels and increases the need to fertilize. Recent research at Ohio State University's extension department of horticulture and crop sciences has shown that when grass clippings are removed from a lawn, 20 to 25 percent more fertilizer is needed to maintain a certain level of color and quality in the lawn than when clippings are returned to the lawn. This increased need for fertilizer is required since the clippings contain measurable amounts of nitrogen, phosphorus and potassium. If sufficiently reduced in size, the clippings returned to the lawn do not contribute to thatch accumulation, and they decompose naturally, returning these nutrients to the soil. For instance, the estimated six million tons of clippings in California contain nearly all of the nitrogen necessary for healthy turf in the entire state. Thus returning the clippings is environmentally friendly in several ways, as it prevents usage of landfill space and unnecessary additional pollution attributable to hauling and disposal and it promotes natural fertilization.

In fact, various programs encouraging the recycling of grass clippings have developed nationwide to encourage the environmentally friendly practice of leaving the clippings on the lawn when mowing. However, this solution does not satisfy the average homeowner who wants a professionally manicured lawn. The sight of rows of unkempt grass clippings is not aesthetically pleasing to the consumer.

One way to remove the unsightly clippings without bagging is to manually rake into compost heaps on-site. Another is to double or triple cut turf to re-cut clippings so as to dispense them into the turf. However, this is both labor and equipment intensive. A solution lies in effective mulching.

Mulching, a process by which grass clippings are cut into smaller and smaller pieces and redistributed into the lawn to compost naturally avoids unnecessary bagging and additional mowing by reducing the size of the grass clippings. Commercial mower manufacturers have tried to produce machines with mulching decks that keep the clippings in the mower deck area or in an additional mulching deck to tear up grass blades into tiny pieces and disperse them back into the grass. However, the cost of these additional machines for the limited use of mulching is not effective for many of those in the landscaping industry and is an especially undesirable purchase for the average homeowner.

Another mechanism to effectively achieve mulching of grass clippings at a greatly reduced cost is using a blade or blade kit that is specially modified to re-cut the clippings after the initial cut is made. The advantage of using mulching blades is that they can be inexpensively mated to a standard mower and mulch the grass clippings. There have been many different approaches to mulching blade designs, but most are engineered to cut and then re-cut the grass, leaving tiny clippings. The smaller the clippings are, the quicker they decompose. However, none of the known mulching blades has achieved a satisfactory reduction in clipping size. Additionally, especially troublesome both for the known mulching blade designs and standard mower blades is wet grass. When wet grass is cut it tends to clump on top of the turf bed and then needs to be double or triple cut, leading to increased costs in time, labor, maintenance and machinery. Similarly, effective mulching of leaves and other large pieces of lawn materials, such as hedge clippings, is especially difficult for the heretofore known blades.

Known blades that purport to be mulching blades include those disclosed in U.S. Pat. Nos. 5,515,670 and 5,291,725 to Meinerding. These are lawn mower blades with a plurality of shredders affixed to the blades. The shredders provide additional cutting edges for mulching. However, the cutting surfaces of the shredders extend up from the main body of the blade and trail back towards the trailing edge of the blade at angles to the primary cutting surface. These embodiments are not very efficient in mulching grass and are ineffective in mulching heavier yard material, such as leaves or wet grass. The grass clippings and especially the larger lawn materials simply ride up and over the secondary cutting surfaces which are angled rearwardly toward the trailing edge or adhere to the blades without being cut.

U.S. Pat. No. 4, 559, 769 to Seyerie provides for a cutting blade with a raised cutting sail. The angle of the sail does not point toward the primary cutting blade. Again full efficiency in cutting of grass clippings cannot be achieved from this embodiment, nor would this design be adequate to handle other lawn materials, as the materials would simply ride over the blade or adhere to the blade.

In yet another example of additional cutting surfaces, U.S. Pat. No. 5,581,987 to Schuyler discloses a mowing blade with a series of additional cutting edges affixed to the sail portion of the blade. Similar sail mounted cutting blades and blades that angle rearwardly toward a trailing edge can be seen in U.S. Pat. No. 5,353,581 to Rouse et al, U.S. Pat. No. 4,269,020 to Wolf, U.S. Pat. No. 3, 998, 037 to Deans et al., and U.S. Pat. No. 3,538,692 to Cope et al. These sail mounted blades and blades that angle rearwardly toward a trailing edge are inadequate for effective mulching, as the grass clippings just pass over the affixed blades affixed to the sails.

Another approach to providing mulching blades is to increase the number of cutting surfaces presented by separating or bifurcating the blade. Examples of this type of design can be seen in U.S. Pat. No. 5,321,940 to Peterson and U.S. Pat. No. 3,780,509 to Woelffer. In both of these designs, a bend in the blade turns up a portion of the blade in a step like fashion. That is the blade is split into two cutting surfaces and the cutting surfaces are separated by a near ninety-degree bend in the mid-portion of the blade body. These up-turned portions present an additional cutting surface parallel to but in a different plane from the primary cutting surface. These additional surfaces are not generally turned or angled relative to the centerline of the blade, but instead are typically shown as being parallel to the horizontal or flat part of the part of the blade that couples to the spindle section, creating a bi-level profile.

These designs, although increasing the number of cutting surfaces, inefficiently utilize these additional cutting surfaces. The grass is cut by the first cutting surface but often passes over the second cutting surface. The bi-level effect of the blades results in less cutting being done by the second cutting surface. In the case of Woelffer, the vacuum or lift of the blade, due to the splitting of the blade surface, is also too low to effectively mulch grass, especially wet grass. Also, in both cases, there are more edges to sharpen and these edges are more difficult to reach, requiring added labor costs to maintain sharp blade edges.

None of the heretofore known blades has been able to provide an efficient mulching blade for use with any mower deck and capable of reducing both grass clippings, wet grass clippings and other landscape remnants to a sufficiently mulched state that they can be effectively returned to the lawn.

There are also further drawbacks to these conventional mulching blades that also apply to conventional lawnmower blades. Mowers mounting conventional blade systems need to be sharpened frequently to maintain the best quality in cutting the turf and other landscape materials encountered in the industry. This sharpening is costly in both equipment down time and labor costs. Additionally, it is difficult to sharpen a blade properly, so as not to affect the balance of the blade. Unbalanced blades can do additional damage by increasing wear and tear on the engines and spindles which, in turn, further drives up maintenance and replacement costs. Moreover, there exists no blade on the market that can be “flipped” or reversed along its longitudinal axis to be reused. This effectively doubles the longevity of the blade and reduces the need for sharpening. Therefore, a need exists for an effective high-lift mulching blade. This blade should also be a self-sharpening blade that is cost-effective to employ.

Thus, there remains a continuing need for more effective, efficient mulching blade that will chop landscape materials of all sorts into smaller pieces and disperse it evenly across the turf to fall out of sight and improve soil conditions, which will in turn require less nutrients and irrigation to achieve a quality looking lawn. Similarly a continuing need exists for a mulching blade or blade system that is self-sharpening and can be quickly and easily attached to a conventional lawn mower.

### SUMMARY OF THE INVENTION

An object of the invention is to provide more effective, efficient mulching blades that will chop landscape materials into smaller pieces and disperse it evenly across the turf to fall out of sight and improve soil conditions.

An object of the invention is to provide a mulching blade that is self-sharpening.

An object of the instant invention is to provide a blade system that is capable of achieving the same cutting efficiency at lower RPM through multiple blade configurations.

Further objects of the invention include extending the life of the equipment, reducing equipment maintenance cost, and conserving oil and gas.

Still another object of the invention is to provide a blade with an increased vacuum and discharge, a so-called high loft blade, capable of removing excess lawn materials.

A further object of the invention is to provide blades with higher speeds and higher vacuums that will allow for more efficient and thorough cutting of the grass clippings and landscape materials into smaller pieces. This in turn results in quicker decomposition and a quicker return of nitrogen and other nutrients to the soil. This is achieved with blades substantially twisted along their entire length and having multiple cutting surfaces.

Yet another object of the invention is to provide a blade that, when mowing over freshly edged hardscapes (sidewalks rounds, etc.) has a vacuum that will be better able to pick up lawn debris and discharge it to a turf area, which in turn will reduce blowing procedures and clean up labor costs.

A still further object of the invention is a blade and blade system with an increased ability to pickup and mulch hedge trimmings, thus reducing the need to rake and bag hedge trimmings and adding additional compost material into the turf.

A still further object of the invention is to cut grass clippings to a substantially smaller size so as not to leave unsightly clippings, this being accomplished through a twisted blade and several finger sections all in rotation with the blade.

Yet another object of the invention is a blade with an increased surface area to provide for initial cutting and increased secondary cutting or mulching of the grass clippings.

Still another object of the invention is a blade that more effectively and efficiently mulches or post-processes grass, leaves, small twigs and other landscape materials utilizing improved secondary cutting surfaces with increased surface area for cutting.

A still further object of the invention is a blade with improved mulching efficiency with secondary cutting surfaces.

Yet another object of the invention is a set of self-sharpening primary and secondary blade surfaces that will reduce wear and tear on equipment by eliminating the need for sharpening.

Yet a further object of the instant invention is a blade system with more than one blade that requires less RPMs to achieve the same cutting efficiency and increases equipment life substantially.

Another object of the invention is a reduction in thatch accumulation due to the high lifting forces/vacuum of the blade and blade system, which lifts thatch from the turf stand and mulches the thatch. The thatch being returned to the turf as organic matter together with any additional mulched lawn materials.

The invention includes a method, an apparatus, and a system for cutting landscape materials to effectively effective mulch the landscape materials.

An exemplary apparatus of the instant invention includes a cutting blade comprising at least one spindle section and at least one blade member extending radially from the at least one spindle section along a longitudinal axis of the blade member and terminating in a distal end. The at least one blade member comprising a first and second blade surface. The at least one blade member also comprising an at least one cutting surface connecting the first and second blade surface at a first cutting angle relative to the plane of the second blade surface. An at least one trailing surface is also part of the blade member. The cutting blade includes a twisted portion rotated at a twist angle substantially throughout the entire cross section of said twisted portion.

The blade of claim can have a cutting angle between about 5 degrees and 85 degrees relative to the plane of second surface. The blade can further comprise at least two finger sections extending from the distal end of the blade toward the spindle section. The width and length of the at least two finger sections can be varied relative to one another. The blade can also comprise three or more fingers. The width and length of the finger sections can also be adjustable.

The at least one cutting surface can further comprise a first cutting surface on said first finger section at the first cutting angle and a second cutting surface on a second finger section having a second cutting angle relative to the plane of the second blade surface. The first cutting surface at a cutting angle from the second blade surface can provide a first cutting edge at the intersection of the first cutting surface and the first blade surface. The first cutting angle can be between about 5 degrees and 85 degrees relative to the plane of second surface. The first cutting angle can also be about 30 degrees.

The extension of the second cutting surface at a second cutting angle from the second blade surface can provide a second cutting edge at the intersection of the second cutting surface and the first blade surface. The second cutting angle can be between about 5 degrees and 85 degrees relative to the plane of second surface. The second cutting angle can also be about 30 degrees.

The at least one trailing surface can further comprise a first trailing surface on said first finger section at a first trailing surface angle relative to the second blade surface and a second trailing surface on said second finger section at a second trailing surface angle relative to the second blade surface. The first trailing surface at a first trailing angle from the second blade surface can provide a first trailing edge at the intersection of the first trailing surface and the first blade surface. The first trailing angle can be between about 95 degrees and 175 degrees relative to the plane of second blade surface. The first trailing angle can also be approximately 120 degrees relative to the plane of second surface.

The second trailing surface at a second trailing angle from the second blade surface can provide a second trailing edge at the intersection of the second trailing surface and the second blade surface. The second trailing angle can be between about 95 degrees and 175 degrees relative to the plane of second blade surface. The second trailing angle can also be approximately 120 degrees relative to the plane of second surface.

The blade can also be rotated 180 degrees about a central axis extending radially from the spindle section through the centerline of the blade to reorient the at least one cutting edge as the at least one trailing edge and the at least one trailing edge as the at least one cutting edge.

A further exemplary embodiment of the instant invention includes a cutting blade comprising a spindle section having a horizontal plane extending radially along a centerline of the blade. The blade also includes at least one blade member extending radially from the spindle section, the blade member having a central axis extending co-extensively with the centerline of the blade and a leading surface and a trailing surface relative to a direction of the rotation of the blade and a first surface and a second surface extending from and joining said leading surface and said trailing surface. With an at least one angled profile provided at the intersection of the leading surface with the first surface and the second surface to form an angled profile with an at least one cutting edge with an at least one cutting section along at least a portion of the blade. The blade also includes an at least one trailing section with a trailing edge along at least a portion of the blade and a twisted portion with a twist angle, relative to the horizontal plane, imparted substantially throughout the entire cross-section of the twisted portion.

The blade can be rotated 180 degrees about its centerline to reorient the at least one cutting edge as the at least one trailing edge and the at least one trailing edge as the at least one cutting edge.

The at least one angled profile can extend from the second surface to the first surface at a cutting angle relative to the plane of the second surface. The cutting angle can be between about 5 degrees and 85 degrees relative to the plane of second surface. The cutting angle can also be about 30 degrees relative to the plane of second surface.

The blade cam further comprise an at least one trailing angled profile for the trailing section, the trailing angled profile extending from the second surface at a trailing angle, relative to the plane of the second surface, to the first surface starting at the trailing edge and to form a trailing surface. The trailing angle can between about 95 degrees and about 175 degrees relative to the plane of second surface. The trailing angle can be approximately 120 degrees relative to the plane of second surface.

The blade can further comprise at least two finger sections extending inwardly from the distal end of the blade member and providing at least two angled profiles and at least two trailing angled profiles. The blade can have three or more fingers.

The twist angle can be between about 0 and about 85 degrees. The twist angle can be greater than the cutting angle. The twisted portion can extend the entire length of the blade member. The twisted portion can also extend for a portion of the length of the blade member.

A further exemplary embodiment of the instant invention includes self sharpening lawn equipment blade comprising a spindle section having a horizontal plane extending radially along a centerline of the blade with an at least one blade member extending radially from the spindle section with at least one cutting surface forming an angled profile extending from a first surface to a second surface at a cutting angle with an at least one cutting edge with an at least one cutting section along at least a portion of the blade and an at least one trailing section. The blade includes a twisted portion extending from the interface between the spindle section and the blade member and incorporating the at least one cutting surface, said twisted portion being twisted at a twist angle relative to the spindle section. The twist angle can be between about 0 and about 85 degrees. The twist angle can be greater than the cutting angle.

A further exemplary embodiment of the instant invention includes a self sharpening lawn equipment blade comprising a spindle section having a horizontal plane extending radially along a centerline of the blade with an at least one blade member extending radially from the spindle section with a first blade surface and a second blade surface and a leading and trailing section relative to the direction of rotation of the blade. The blade includes a twisted portion extending from the interface between the spindle section and the blade member and incorporating the at least one cutting surface, said twisted portion being twisted at a twist angle relative to the spindle section and at least one cutting surface section with an at least one cutting edge along at least a portion of the blade and extending between the first blade surface and second blade surface at a cutting angle and having a differential angle relative to the horizontal plane of the spindle section. The blade also includes an at least one trailing section extending along a portion of said trailing surface.

The differential angle can be the difference between the twist angle and the cutting surface angle. The differential angle can be positive. The differential angle can between about 0 degrees and about 20 degrees. The differential angle can be about 15 degrees.

An exemplary method of making the instant invention includes a method of making a cutting or lawn equipment blade comprising the steps of providing a blade blank with a spindle section and at least one blade member, the at least one blade member having a leading edge and a trailing edge and a first and second surface. Cutting the blade blank to provide an at least one cutting surface the at least one cutting surface being cut into the leading edge of the blade blank at a cutting surface angle relative to the first and second surfaces. Twisting the blade along a twisted portion of the blade member through a twist angle throughout substantially its entire cross section.

The method can further comprise the method step of removing at least one section between the at least one cutting surface and an at least one trailing surface to provide at least two finger sections. The method can also further comprise the method step of removing two or more sections between the at least one cutting surface and an at least one trailing surface to provide three or more finger sections.

### BRIEF DESCRIPTION OF THE DRAWINGS

Embodiments of the invention are explained in greater detail by way of the drawings, where the same reference numerals refer to the same features.

FIG. 1 shows a side view of an exemplary embodiment of the instant invention;

FIG. 2 shows a close up side view of one blade member of an exemplary embodiment of the instant invention;

FIG. 3A shows a cross-sectional view along the distal end of the blank from which an exemplary embodiment of the instant invention is cut;

FIG. 3B shows a cross-sectional view of an intermediate step of cutting out the exemplary embodiments of FIGS. 1 and 2 or an additional exemplary embodiment along the distal end of the blade prior to twisting the invention;

FIG. 3C shows a cross-sectional view of the exemplary embodiments of FIGS. 1 and 2 along the distal end of the blade prior to twisting the invention;

FIGS. 4 shows a cross-sectional view of the exemplary embodiment of FIG. 1 along the distal end of the blade after twisting;

FIGS. 5 shows a close up cross-sectional view of the first finger section of the exemplary embodiment of FIG. 1 along the distal end of the blade;

FIGS. 6 and 7 show side views of additional exemplary embodiments the instant invention;

FIG. 8 shows an exemplary embodiment of a non-twisted, self-sharpening form of the instant invention.

### DETAILED DESCRIPTION OF THE INVENTION

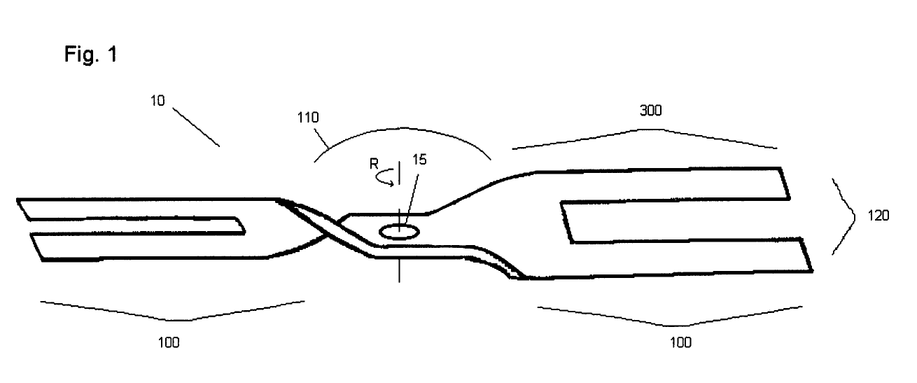

FIG. 1 shows a side view of an exemplary embodiment of the instant invention. The invention comprises a blade 10 for use with lawn equipment, particularly lawn mowers. Typically, the lawn equipment utilizes the blade in a rotary cutting application, therefore the blade 10 has an associated direction of rotation R, which can be either counter-clockwise or clockwise. The blade 10 comprises two blade member sections 100 connected by a spindle section 110. Spindle section 110 has a spindle hole 15 therethrough. Each blade member 100 has a distal end 120 displaced from the spindle section 110. In the exemplary embodiment shown, the blade member sections 100 are mirror images of one another to facilitate operation of the blade 10 in a piece of lawn equipment. Thus, each of the blade member sections 100 is identical except for the orientation of the respective blade member 100 relative to the direction of rotation R of the blade 10 over the entirety of the blade. Put another way, when looking at the total length of the blade in the side view, one section is facing toward the viewer and the other away. The orientation shown does not exclude the possibility, in further exemplary embodiments, of modifying the blade for special applications in which the orientation of the blade members 100 is different from any of the exemplary embodiments depicted. For example modifications wherein the blade members have identical orientation across the length of the blade or one or the other blade members is modified to be dissimilar from the instant invention. However, to simplify the application and the accompanying figures, reference and description is made herein to a single blade member 100.

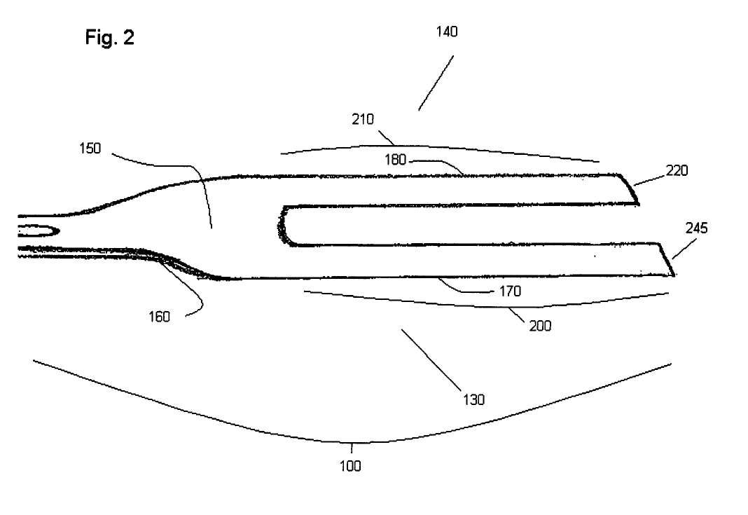

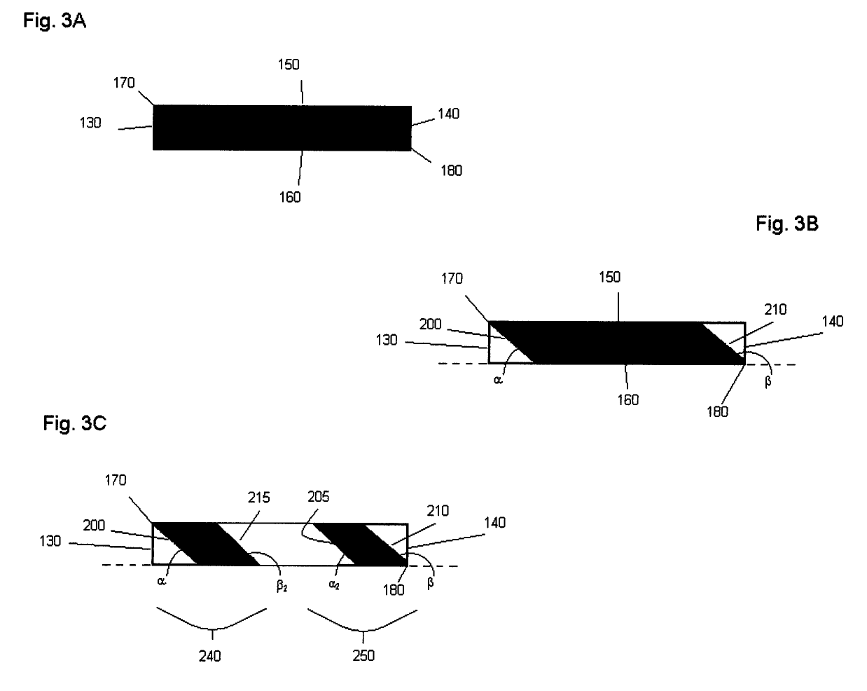

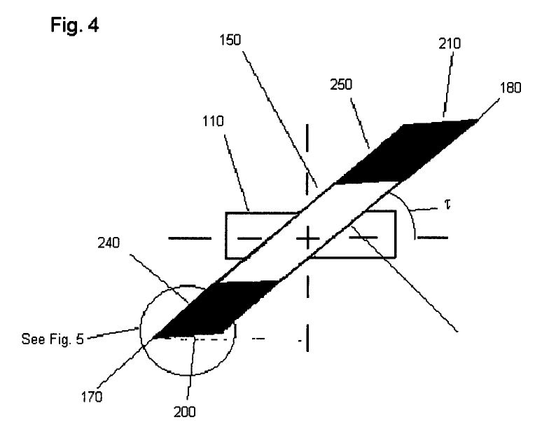

FIG. 2 shows a close up side view of one side of an exemplary embodiment of the instant invention. The blade member 100 has a leading surface 130 and a trailing surface 140 relative to the direction of the rotation of the blade 10. The blade member also has a first or upper surface 120 and a second or lower surface 160 that extend from and join the leading surface 130 and the trailing surface 140. As further described below in relation to FIGS. 3B and 3C, the leading surface 130 and the trailing surface 140 both intersect the first surface 150 and the second surface 160 to form profiles having a first or primary cutting section or surface 200 with a primary cutting edge 170 and a second or secondary trailing section or surface 210 with a secondary trailing edge 180 along at least a portion of the blade 10. These profiles are then oriented at a twist angle r, as shown and described in FIG. 4, throughout at least a portion of blade 10. This portion being shown as a twist portion 300 in the figures. The twist portion 300 and the resulting cutting surfaces described in relation to the drawings are significantly different than existing blades in that the cutting surface or surfaces are twisted throughout the blades cross section. The blades do not provide a bi-level split, as seen in some of the prior art. Instead, a twist provides an angle of attack that is carried substantially throughout the blades unique profile and helps to provide the distinctive reversed cutting edge, as described further in regards to FIGS. 3-5.

FIG. 3A shows a cross-sectional view along the distal end of the blank from which an exemplary embodiment of the instant invention is cut. As can be seen in FIG. 3A, the body member has a leading surface 130, a first or top surface 150, a bottom or second surface 160, and a trailing surface 140. In addition, the edges that will become the primary cutting edge 170 and secondary trailing edge 180 after the blade is cut are shown.

FIG. 3B shows a cross-sectional view of an intermediate step of cutting out the exemplary embodiments of FIGS. 1 and 2 or an additional exemplary embodiment along the distal end of the blade prior to twisting the invention. The leading surface 130 of the blade member 100 has a profile cut along a primary cutting surface section 200. As can be seen in the Figure, the primary cutting surface 200 is shown after it is cut from the leading surface 130 to provide an angled profile. The angled profile extending from the second surface 160 up to the first surface 150, intersecting the first surface at the primary cutting edge 170, at an angle α relative to the primary cutting surface 200 and the plane of second surface 160. In exemplary embodiments, angle α is between about 5 degrees and about 85 degrees relative to the plane of second surface 160. In the exemplary embodiment depicted in the figures, α is about 30 degrees.

The trailing face 210 is also shaped to form an angled profile. A similar cut is made in trailing surface 140 from the second surface 160 to the first surface 150, starting at the secondary trailing edge 180, to form an angle β relative to the secondary trailing face 210 and to the plane of second surface 160. In exemplary embodiments angle β is between about 95 degrees and 175 degrees. In the exemplary embodiment shown angle β is about 120 degrees.

The length of the primary cutting surface 200 and that of primary cutting edge 170 can be varied to suit specific applications, deck sizes, and other parameters. In some exemplary embodiments, the length of the primary cutting edge 170 can be more than twenty-five percent of the overall length of the blade. In others the length of the primary cutting edge 170 can be more than thirty-three percent of the overall length of the blade. In still others, the length of the primary cutting edge 170 can be more than fifty percent of the overall length of the blade. In still others, the entire length of the blade portion 100 can be twisted in relation to the spindle section 110.

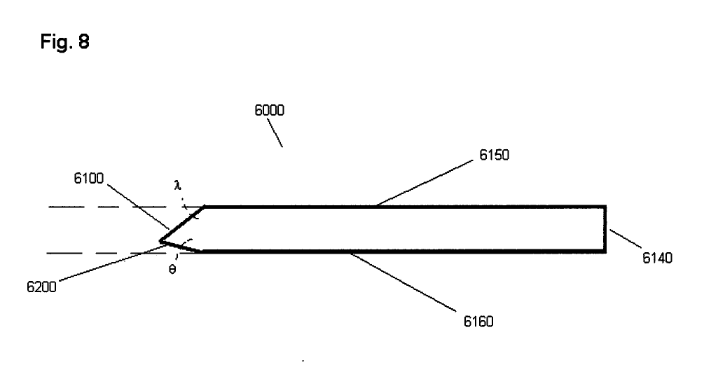

The blade 10, in the form shown in FIG. 3B, can also be used as a further embodiment of the instant invention, one without the additional cut in the middle of the blade shown in FIGS. 1 and 2. This alternative embodiment would have no finger sections, having a solid blade member and providing maximum lift to aid in efficient mulching and can still be able to provide the self-sharpening capabilities of the instant invention, as discussed further herein. In this further exemplary embodiment, the blade would simply be twisted at this point in the manufacturing process. In still another exemplary embodiment of the invention, the trailing surface 140 may be left uncut, similar to conventional blades, providing the additional lift and mulching capabilities of the instant invention and also still being able to be made self-sharpening on the existing cutting edges. Also in the exemplary embodiment shown in FIGS. 1-5, the primary cutting surface section 200 extends along substantially the entire blade member 100. Similarly, the trailing surface 210 extends along substantially the entire blade member 100. In additional embodiments of the instant invention, these surfaces can extend for a limited portion of the blade member 100, as further described below in relation to FIGS. 7 and 8. However, in the exemplary embodiment of FIGS. 1 and 2, additional cuts are made, as described below in relation to FIG. 3C.

FIG. 3C shows a cross-sectional view of the exemplary embodiments of FIGS. 1 and 2 along the distal end of the blade prior to twisting the invention. To produce the exemplary embodiment shown in FIG. 1, a section between the primary cutting surface 200 and the secondary trailing surface 210 is cut from the distal end 120 of the blade member 100 producing first finger section 240 and second finger section 250. Additional cuts can be made to provide additional finger sections. Similarly wider, narrower, longer or shorter cuts into the blade member 100 can be made to widen, narrow, lengthen or shorten the finger sections relative to the overall blade member 100. In an exemplary embodiment, for instance, the width of finger section 250 may be one-third the width of the blade and in further exemplary embodiments this width could be three eighths of the blades width.

The primary cutting surface 200 and the secondary trailing surface 210 are the same as those described above in relation to FIG. 3B. The first or primary trailing surface 215 of the first finger section 240, in the exemplary embodiment, is also cut to provide a profile. In the exemplary embodiment, the primary trailing surface 215 of the first finger section 247 has the same profile as that disclosed above for secondary trailing surface 210. In FIG. 3C the angle of the primary trailing surface 215 of the first finger section 247 with the second surface 160 is denoted by β₂. It should be noted that in additional embodiments of the instant invention the angle β₂ could be varied from β. The angle β₂, similar to β, may be between about 0 degrees and about 85 degrees.

Similarly, the second finger section 250 shares an identical profile for the second or secondary cutting surface 205 of the second finger 250 as that of primary cutting surface 200 described above. The angle of the secondary cutting surface 205 of the second finger 250 is denoted by α₂ in FIG. 3C. Again, although the exemplary embodiment depicted has equal angles for the corresponding surfaces of the first and second fingers, further exemplary embodiments can vary the angles relative to one another. The angle α₂, similar to α, may be between about 0 degrees and about 85 degrees.

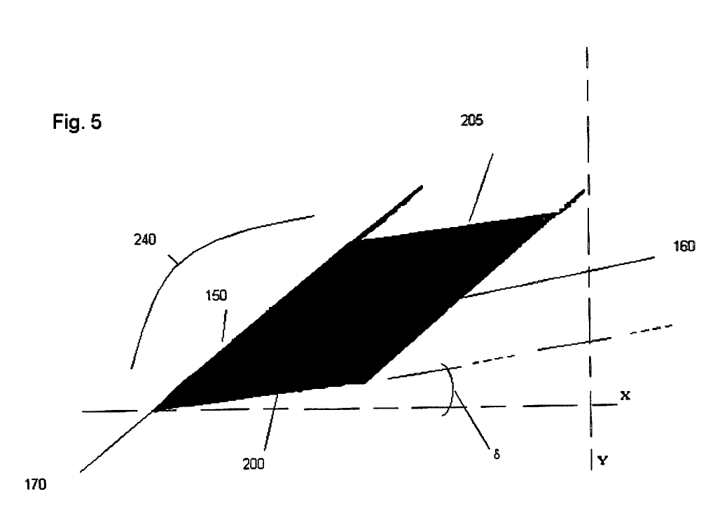

FIG. 4 shows a cross-sectional view of the exemplary embodiment of FIG. 1 along the distal end of the blade after twisting. As seen in FIGS. 1 and 2, at a point spaced from the spindle hole 15, at the interface between the spindle section 110 and the blade member 100, the exemplary embodiment shown has a body member that is twisted at an angle τ relative to the spindle section 110. Put another way, the blade is twisted through substantially its entire cross-section along a twisted portion 300, which runs the entire length of the blade member 100 in the embodiment of FIG. 1, at an angle τ relative to the plane of the spindle section. The angle τ can be up to about 85 degrees. The angle τ in the exemplary embodiment shown is substantially about 45 degrees. To provide the self-sharpening aspects of the blade, the angle τ must exceed angle α or the cutting surface angle on any surface that is to be self-sharpening, so that the cutting surface in question trails back at a slight slope from its cutting edge as further shown in relation to FIG. 5. It should be noted that the embodiments of the instant invention can be provided with or without this self-sharpening aspect and still provide significant benefits to the user, for example, and certainly not limited to, increased lift and mulching capability.

FIG. 5 shows a close up cross-sectional view of the first finger section of the exemplary embodiment of FIG. 1 along the distal end of the blade. This figure shows the orientation of one of the self-sharpening cutting surfaces of the exemplary embodiment. A differential angle δ is shown for the primary cutting surface 200, which slopes away from the primary cutting edge 170 at differential angle δ after the application of the twist angle τ through the blade member 100. The differential angle δ can be expressed mathematically as δ=τ−α. The differential angle δ in some exemplary embodiments can be between about 0 degrees and about 20 degrees. In other exemplary embodiments, the differential angle δ is between about 0.1 and about 5 degrees. In the exemplary embodiment depicted, differential angle δ is about 2 degrees. By providing this sloping back orientation of the primary cutting surface the instant invention allows the cutting edge of the blade to wear backwards along the slope, retaining a sharpened cutting edge. In this case, the primary cutting edge 170 continues to move back along the primary cutting surface 200, which slopes back at differential angle δ, as the blade experiences wear.

The differential angle δ along the twisted portion 300 puts the profile of the primary cutting surface 200, the secondary cutting surface 205 and any additional cutting surfaces associated with additional fingers in the exemplary embodiments in an orientation to cut lawn materials and remain sharp as the cutting edge is worn backwards along the slope of the cutting surface. The same or similar profiles as those described above, including any varying of the angles α, β, and τ, will provide a similar self-sharpening cutting surface so long as the blade member 100 is oriented in the way described above in relation to FIG. 5. It should also be noted, as mentioned previously, the twisted portion 300 of the blade member 100 is substantially the entire blade member 100 in the exemplary embodiment shown. In alternative embodiments, the twisted portion 300 can be less than the entire blade member 100 and, therefore, the self-sharpening portion of an exemplary embodiment can be less than the entire blade member 100. Similarly, the self-sharpening portion need not be the entire length of the twisted portion.

The exemplary embodiment depicted in FIGS. 1-5 can also be rotated to “reverse” the direction and facing of the blade members 100, since the blade is symmetrical about its longitudinal axis. Thus the blade 10 can be reoriented so that the trailing surface 210 becomes the primary cutting edge 200 and, similarly, any additional trailing edges are likewise reversed to become leading edges. Put another way, the blade can be rotated about its longitudinal axis 180 degrees resulting in a reverse of the both blade members 100 orientation of the respective cutting and trailing edges relative to the rotation of the blade 10. This allows for the use of the unworn trailing edges as cutting edges, thereby extending the life of the blade and reducing the need for sharpening even further.

The blade 100 can also be manufactured in a very cost-effective manner. The method of manufacture can include all or some of the following steps. The method of manufacturing the exemplary embodiments of the blades begins with the blank show in FIG. 3A. The blade members 100 are cut from the blade blank to provide at least a primary cutting surface at an angle α relative to the first and second surfaces 150, 160 as substantially described above in relation to FIG. 3B. In the exemplary embodiment depicted in FIG. 1, a section is removed between the primary cutting surface 200 and the trailing surface 210 to provide at least two finger sections 220, 245. These finger sections can be cut to provide surfaces and edges similar to the at least one primary cutting surface. The blade is then twisted into its final form show in FIGS. 1, 2, and 4. Variations in the order of these steps, the number of fingers cut into the blade and the profile angles of the surfaces can be accomplished without departing from the spirit of the instant invention.

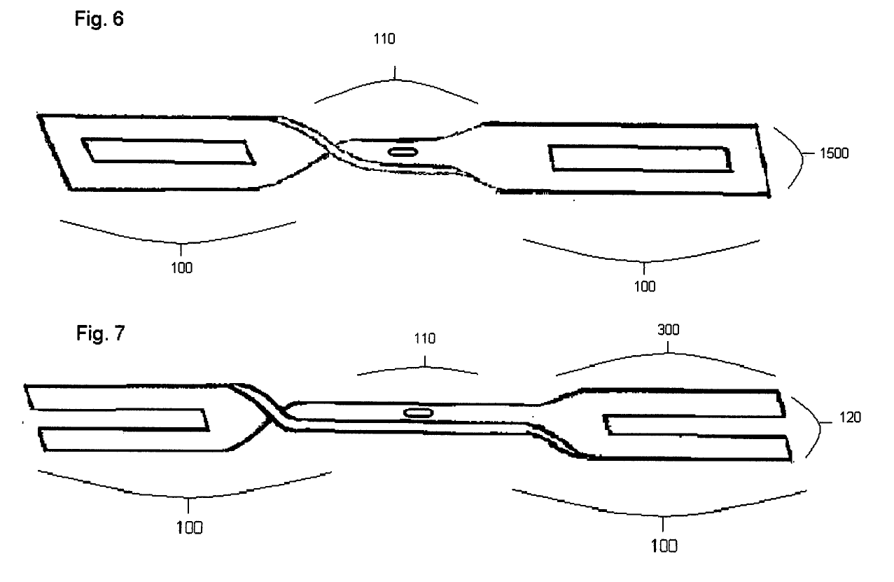

FIGS. 6 and 7 show side views of additional exemplary embodiments of the instant invention. FIG. 6 shows a side view of an exemplary embodiment with a closed end. This exemplary embodiment has the same blade member 100 described above in relation to FIGS. 15, including the angles α, β, and τ, but has increased rigidity as it has a closed distal end 1500 instead of the cut distal end shown in FIGS. 1-5. Effectively, first finger section 220 and second finger section 240 are connected at the distal end 1500 in this embodiment. This provides a more rigid blade suitable for areas with rougher terrain features.

FIG. 7 shows an exemplary embodiment in which twisted portion 2500 extends from a middle portion of blade member 100 through the distal end 120 instead of the entire length of the blade member 100 as seen in FIGS. 1-5. This provides a lower vacuum blade with the exemplary properties of the instant invention.

FIG. 8 shows an exemplary embodiment of a non-twisted, self-sharpening embodiment of the instant invention. The blade member 6000 is shown in cross-section, it is flat blade member, having a first surface 6150, a second surface 6160, a trailing surface 6140, and a leading surface 6130. The leading surface is cut on two angles λ and θ relative to the first surface 6150 and the second surface 6160, respectively. The cuts are made from the respective surfaces to a leading cutting edge 6200. This provides the self-sharpening aspect to a conventional blade shape.

It should also be noted that typically a lawn mower blade is sharpened from a leading cutting edge back towards a first or upper surface 160. However, the instant invention includes a reverse sharpened profile as shown in FIGS. 3B, 3C and 4, where the primary cutting surface 200 goes from the first or top surface 150 to the second or bottom surface 160. This is the reverse of the typical lawnmower blade cutting edge orientation. This aspect is unique and can be employed in all the exemplary embodiments shown and additionally, it can be imparted in conventional blades, as shown in reference to FIG. 8. The unique design aids in cutting and mulching of grass clippings and reduces the need for sharpening, especially when provided with the aforementioned angular configurations. Moreover, the reverse cut reduces the need for polishing and grinding to provide a cutting edge.

The embodiments and examples discussed herein are non-limiting examples. The invention is described in detail with respect to preferred or exemplary embodiments, and it will now be apparent from the foregoing to those skilled in the art that changes and modifications may be made without departing from the invention in its broader aspects, and the invention, therefore, as defined in the claims is intended to cover all such changes and modifications as fall within the true spirit of the invention.

What is claimed is:

1. A blade comprising:
at least one spindle section; and
at least one blade member extending radially from the at least one spindle section along a longitudinal axis and terminating in a distal end, the blade member having a direction of rotation and comprising:
a first blade surface and second blade surface;
an at least one cutting surface connecting the first and second blade surface at an at least one cutting angle relative to the at least one cutting surface and the plane of the second blade surface;
an at least one trailing surface relative to the direction of rotation of the blade member;
a twisted portion rotated at a twist angle substantially throughout the entire cross section of said twisted portion.

2. The blade of claim 1, wherein the at least one cutting angle is between about 5 degrees and 85 degrees relative to the at least one cutting surface and the plane of second surface.

3. The blade of claim 1, wherein the blade member further comprises at least two finger sections extending from the distal end of the blade toward the spindle section.

4. The blade of claim 3, wherein the width or length of the at least two finger sections is varied relative to one another.

5. The blade of claim 3, wherein the at least one cutting surface and at least one cutting angle further comprises a first cutting surface on said first finger section at a first cutting angle relative to the first cutting surface and the plane of the second blade surface and a second cutting surface on said second finger section having a second cutting angle relative to the second cutting surface and the plane of the second blade surface.

6. The blade of claim 5, further comprising a first cutting edge at the intersection of the first cutting surface and the first blade surface.

7. The blade of claim 6, wherein the first cutting angle is about 30 degrees relative to the first cutting surface and the plane of second surface.

8. The blade of claim 5, further comprising a second cutting edge at the intersection of the second cutting surface and the first blade surface.

9. The blade of claim 8, wherein the second cutting angle is about 30 degrees relative to the second cutting surface and the plane of second surface.

10. The blade of claim 3, wherein the at least one trailing surface further comprises a first trailing surface on said first finger section at a first trailing surface angle relative to the plane of the second blade surface and a second trailing surface on said second finger section at a second trailing surface angle relative to the plane of the second blade surface.

11. The blade of claim 10, further comprising a first trailing edge at the intersection of the first trailing surface and the first blade surface.

12. The blade of claim 11, wherein the first trailing angle is between about 95 degrees and 175 degrees relative to the first trailing surface and the plane of second blade surface.

13. The blade of claim 10, further comprising a second trailing edge at the intersection of the second trailing surface and the second blade surface.

14. The blade of claim 13, wherein the second trailing angle is between about 95 degrees and 175 degrees relative to the second trailing surface and the plane of second blade surface.

15. The blade of claim 1, wherein the blade is rotated 180 degrees about a central axis extending radially from the spindle section through the centerline of the blade to reorient the at least one cutting edge as the at least one trailing edge and the at least one trailing edge as the at least one cutting edge.

16. A cutting blade comprising:
a spindle section having a horizontal plane extending radially along a centerline of the blade;
at least one blade member extending radially from the spindle section, the blade member having a central axis extending co-extensively with the centerline of the blade and comprising
a first leading surface and a first trailing surface relative to a direction of the rotation of the blade and a first surface and a second surface extending from and joining said leading surface and said trailing surface;
an at least one angled profile provided at an intersection of the leading surface with the first surface and the second surface to form an at least one cutting section with an at least one cutting edge;
an at least one trailing section with an at least one trailing edge; and
a twisted portion with a twist angle, relative to the horizontal plane, imparted substantially throughout the entire cross-section of the twisted portion.

17. The blade of claim 16, wherein the at least one angled profile extends from the second surface to the first surface at a cutting angle relative to the cutting section and the plane of the second surface.

18. The blade of claim 16, wherein the twist angle is between about 0 and about 85 degrees.

19. The blade of claim 17, wherein the twist angle is greater than the cutting angle.

20. The blade of claim 3, wherein the twisted portion extends the entire length of the blade member.

21. A self sharpening lawn equipment blade comprising:
a spindle section having a horizontal plane extending radially along a centerline of the blade;
at least one blade member extending radially from the spindle section with a first blade surface and a second blade surface and a leading and trailing section relative to the direction of rotation of the blade;
a twisted portion extending from the interface between the spindle section and the blade member and incorporating the at least one cutting surface, said twisted portion being twisted at a twist angle relative to the spindle section; and
at least one cutting surface section with an at least one cutting edge along at least a portion of the blade and extending between the first blade surface and second blade surface at a cutting angle and having a differential angle relative to the horizontal plane of the spindle section; and
an at least one trailing section extending along a portion of said trailing surface.

22. The blade of claim 21, wherein the differential angle is the difference between the twist angle and the cutting surface angle.

23. The blade of claim 22, wherein the differential angle is positive.

24. The blade of claim 23, wherein the differential angle is about 2 degrees.

25. The blade of claim 3, wherein said at least two finger sections are within the twisted portion of the blade member and are twisted and parallel to one another, sharing a common plane of the second blade surface.

26. The blade of claim 16, wherein the at least two angled profiles have a first and second cutting section and said first and second cutting section are parallel to each other and share a common angled plane relative to and intersecting the horizontal plane of the blade.

27. The blade of claim 22, wherein the difference between the twist angle and the cutting angle is between about 0 degrees and about 20 degrees

28. The blade of claim 27, wherein the difference between the twist angle and the cutting angle is between about 2 degrees.

29. A self sharpening lawn equipment blade comprising:
a spindle section having a horizontal plane extending radially along a centerline of the blade;
at least one blade member extending radially from the spindle section with a first blade surface and a second blade surface and a leading and trailing section relative to the direction of rotation of the blade;
a twisted portion extending from the interface between the spindle section and the blade member and incorporating the at least one cutting surface, said twisted portion being twisted at a twist angle relative to the spindle section; and
at least one cutting surface section with an at least one cutting edge along at least a portion of the blade and extending between the first blade surface and second blade surface at a cutting angle and having a differential angle relative to the horizontal plane of the spindle section; and
an at least one trailing section extending along a portion of said trailing surface.
